(19) United States
(12) Patent Application Publication
(10) Pub. No.: US 2011/0078878 A1
(43) Pub. Date: Apr. 7, 2011

(54) HARNESS FOR MOUNTING LARGE SHEETS OF MATERIAL ON BOX-LIKE BODIES

(76) Inventor: Henry George Potrykus, Lindenhurst, IL (US)

(21) Appl. No.: 12/573,260

(22) Filed: Oct. 5, 2009

(51) Int. Cl. A44B 99/00; B23P 11/00

(52) U.S. Cl. 24/1; 29/525.01

(57) ABSTRACT

A mounting assembly on a box-like body is provided allowing the mounting of large material sheets on the box-like body. The mounting assembly includes a set of straps configured to rest on the box-like body and sit under connective tension via a securing mechanism so that the configuration of the straps be stably maintained. The large material sheets may then be secured to the mounting assembly and hence be made to rest stably along the box-like-body.

### BACKGROUND

1. Field of the Invention

The invention relates to mounting apparatuses. More specifically, the invention relates to mounting apparatuses for tarps, images, banners and equivalents on bodies such as truck trailers, ISO containers, light-rail or subway cars, or equivalents.

2. Background

Within the area of the invention, tarps are often mounted with poles or rods over a dump truck. Those assemblies have metal poles, and have those poles (semi-permanently) fixed to the trailer mechanically, at times like a pitched tent with a frame for maintaining the tent in some shape.

Images may be affixed to such bodies through a variety of technologies. Often these technologies are informally called ‘wraps.’ The affixing of the images with these technologies is truly superficial—meaning the affixed product forms only a thin covering or coating on the already existing surface of the body. The process for affixing is often thermo-chemical and adhesive in nature.

Through another means, a banner or potentially thicker cardboard sign may be fixed to the body. Here a frame (much like a picture frame) is first mechanically fixed to the side of the body—the body being often a bus or other public transportation vehicle like a (light-rail) metro or subway car. This first mechanical act requires specialized components. It also requires change of the physical constitution of the body itself, as bolt- or rivet-holes must perforate the walls of the body. This is because, in general, purely adhesive mounting of the frame is to be discouraged as this may not maintain fixture integrity for the duration (years) of exposure of the assembly to the elements.

Inventions within this and other fields are described in the following patents: US 20090175699 A1, U.S. Pat. No. 5,954,076, U.S. Pat. No. 5,507,109 A, US 20080019788 A1, U.S. Pat. No. 6,142,553, U.S. Pat. No. 4,342,480, U.S. Pat. No. 3,290,743 A, U.S. Pat. No. 4,172,614 A, U.S. Pat. No. 4,991,328 A, U.S. Pat. No. 5,193,955 A, U.S. Pat. No. 4,278,284, U.S. Pat. No. 5,845,423 A, U.S. Pat. No. 6,530,165, U.S. Pat. No. 5,239,765, U.S. Pat. No. 5,507,109.

These and other concerns with current mounting apparatuses exist.

### SUMMARY

The mounting assembly of the present invention is truly general—meaning it affords many mounting possibilities, while still being stable and simple to build and maintain—making the technology economically efficient, effective, practical, and affordable. The assembly can thus be likened loosely to the straps found on a camper's backpack, which though inexpensive, are nonetheless strong, reliable, and useful for fixing all manner of external hangings to the camper's pack.

Like the complex riggings of ropes and sheets of material (sails) found on ocean-going sailing ships of old, it not important what particular fastener, knot or twist or length of cord or strap participates in making up the geometric form of loops and connectors of the assembly. The physical geometrical form is designed 1) to have stability to shocks as may be found in the transiting of the enmeshed box-like body; 2) to have broad applicability to the coverings which will be attached to it—e.g. over-the-top or on-the-side tarps, banners, or images printed on a wrap-around canvases, or equivalents; 3) to use an economical amount of inexpensively available construction material (either straps, cord or webbing—that is, a flat strap, usually woven from synthetic polymer strands such as polypropylene), note however that this is an optional, though often desirable feature—more, or more expensive, material may be used to suit particular needs; 4) to be easy to safely and effectively installed.

To wit, the invention includes the resultant physical geometric form of closed, or partially-formed and perhaps fixed-to-the-body, loops and straps found at predetermined regions around the box-like body. The subsequent employment of this assembly is to attach on the box-like body various sheets of material. It is the stability of the assembly, both against along-box-edge and perpendicular-to-box-edge perturbations of the assembly or the mounted articles that is among the important aspects of this invention.

The invention includes a mounting assembly including a set of straps, whose employment results in the constructing of at least four geometrically discernible loops, or geometrically discernible partially-closed loops of straps that are secured to the body so each geometrically discernible partially-closed loop maintains its loop-like form.

The box-like body in general has two sets of four discernible shorter, parallel edges as well as four long, horizontal edges running the length of the body. The four discernible loops or partially-closed loops act as rings around four shorter, parallel edges of one of the sets of four shorter, parallel edges of the box-like body. These edges need not be, and generally are not, all sharp, as is the case, for example, for several tractor trailer styles, which have rounded edges for aerodynamic, stylistic, or other purposes. For this reason, the four discernible loops or partially-closed loops often circumscribe the four shorter, parallel edges in fairly large loops, if stability of the loops is to be preserved, and the de-looping of any of these edges be avoided. Also note that these four discernible loops or partially-closed loops may be formed, conceivably by one long length of strap, but more typically from two or more lengths of strap. In the latter case, encircling loops encircling front parallel edges could be formed from one length of strap, here the two encircling loops are formed by simply twisting, or otherwise fastening and delineating, the strap's planar topology (that is, forming the discernible loop purely by holding lengths of the strap in certain places so that the loops are formed perceptively and geometrically and not by any physical cutting of the strap) so that each encircling loop now does encircle the front parallel edges. These considerations notwithstanding, the preferred embodiment is to form each of the four discernible loops or discernible partially-closed loops from an individual length of strap.

The four discernible loops or discernible partially-closed loops are then to be secured stably to their places encircling the shorter, parallel edges of the box-like body by a securing mechanism. This securing mechanism can be formed from a variety of constituents, the preferred embodiment of which is with two other discernible loops, these two loops formed to lie on two opposite length-wise running, long, faces of the box-like body. These faces will often be the vertical side faces of the box-like body. The four discernible loops or partially-closed loops are secured stably by fastening them in some manner, such as via twisting-together, clips, carabiners, sewing, or other loops of strap, or equivalents to the two loops on the long side faces of the box-like body.

The securing mechanism could also include sheets of material running along at least two opposite length-wise faces of the box-like body. The four discernible loops or discernible partially-closed loops are secured stably by fastening them in some manner to each of the corners of the material sheets, such as via threading the straps through perforations, via knotting—such as a sheet-bend knot, by clips or carabiners, by sewing, or by another loop of strap connected to those corners of the material sheets, or equivalents.

In an alternate embodiment, the securing mechanism could include simple lengths of straps (i.e. without the loops), these simple lengths of straps will then connect the four discernible loops or partially-closed loops to one another, e.g. a front-top discernible loop or discernible partially-closed loop is connected to a back-bottom discernible loop or discernible partially-closed loop and a back-top discernible loop or discernible partially-closed loop is connected to a front-bottom discernible loop or discernible partially-closed loop via the straps. In the case of making even these side-face lengths of straps very short, the four discernible loops or discernible partially-closed loops may be secured stably by fastening them to one-another directly in some manner, such as via a twisting-together, one or more clips or carabiners, or another, perhaps very small, loop of strap. In another example configuration, where right and left are determined arbitrarily from some view towards the box-like body, but are fixed, a front-right discernible loop or discernible partially-closed loop is connected to a back-left discernible loop or discernible partially-closed loop and a back-right discernible loop or discernible partially-closed loop is connected to a front-left discernible loop or discernible partially-closed loop via the straps.

With the four discernible loops or partially-closed loops secured stably by some securing mechanism, for example one of those as given above, the four discernible loops or discernible partially-closed loops may be additionally stabilized by running straps between them along the top, front, bottom, and back faces, or along a side, front, other side, and back faces of the box-like body. These additional stabilizing straps help to stabilize the four discernible loops or partially-closed loops against perturbative motions in the forward, backward, and up, down or right, left, and forward- or backward-rotational, directions, as they may supply tension which helps keep the four discernible loops or discernible partially-closed loops from moving in the direction anti-parallel to the forces of tension.

One may also employ other, tension-lending connector straps, or additional tension-lending sheets of material. For example, if loops are employed along side length-wise faces of the box-like body, various points of those loops can be kept from sagging if straps are run over the top of the box-like body and connected to the loops on the side length-wise faces of the box-like body. These straps run over the top of the body may provide, for example, tension to keep the top edges of the side-face loops from sagging. Likewise, if material sheets are employed, other straps or material sheet extensions may be run over the top of the body and be connected to or be a continuous extension to the material sheets running along the side length-wise faces of the box-like body. The other straps or material sheet extensions may then provide tension to keep the top edges of the material sheets running along side length-wise faces of the box-like body from sagging.

To keep any stabilizing strap running along the bottom of the box-like body from getting entangled in any mechanical equipment found on the bottom of the box-like body, a strap running from it to a side-face loop may be employed to move the bottom stabilizing strap to the side of the bottom face and away from any mechanical devices that may be present on that bottom face.

Another innovative aspect of the invention is the generality by which sheets of material of varying thickness such as thicker cardboard placards, tarps, banners, and thin wrappers may be attached to the assembly, and hence affixed up to and possibly around faces of the box-like body, either by cords, wraps, knots, sewing, or mechanical contraptions such as clips, carabiners, snaps, small closed loops of straps, other fasteners, or equivalents. The most stable—lending full three-dimensional stability to any attached entity—connection points are those points where the edge loops or partially-closed edge loops and any stabilizing mechanism are joined; either topologically, as by twisting or knotting or equivalents; or mechanically, as by additional carabiners, clips or other equivalents. The sheets of material may also be attached to other points of the assembly to improve other physical aspects of the layout of the sheets of material, such as, e.g., tautness, or convenience of attachment and detachment of the sheets of material, among other possible useful aspects.

It is its practical, economic advantages that prove the novelty and non-obviousness of this invention; other similar inventions are more specific to a task, and even though they may perform the task adequately, this invention is in typical employment scenarios less expensive in its material and labor costs to implement, while it is frequently found to be as or more mechanically stable than the predecessor technologies.

### BRIEF DESCRIPTION OF THE DRAWINGS

FIG. 1A is a top perspective view of a mounting assembly on a box-like body, with four edge-encircling loop straps, side-face loops as the securing mechanism, an optional pull-up strap for the securing mechanism, and optional front and top stabilizing straps, according to an embodiment of the invention;

FIG. 1B is a bottom perspective view of a mounting assembly on a box-like body, with four edge-encircling loop straps, side-face loops as the securing mechanism, an optional pull-up strap for the securing mechanism, optional front and bottom stabilizing straps, and an optional strap to pull over the bottom stabilizing strap, according to an embodiment of the invention;

FIG. 1C is a front elevation view of a mounting assembly on a box-like body, with two edge-encircling loop straps at the front of the body, and an optional front stabilizing strap, according to an embodiment of the invention;

FIG. 1D is a side elevation view of a mounting assembly on a box-like body, with four edge-encircling loops, a side-face loop as the securing mechanism, and an optional pull-up strap for the securing mechanism, according to an embodiment of the invention;

FIG. 2A is a top perspective view of a part of a mounting assembly on a box-like body, with two edge-encircling loop straps at the front and back of the body, wherein the front loop strap is shown folded over to create the front-top and front-bottom edge encircling loops, according to an embodiment of the invention;

FIG. 2B is a front elevation view of a mounting assembly on a box-like body, with an edge-encircling loop strap at the front of the body, wherein the front loop strap is shown folded over to create the front-top and front-bottom edge encircling loops, the dashed line calls out the part of the single strap which is folded under, and then fastened in some manner, to the rest of the single strap, according to an embodiment of the invention;

FIG. 3 is a top perspective view of a part of a mounting assembly on a simple box-like body, with one edge-encircling loop strap for the entire body, wherein the loop strap is shown folded over on the front face of the body to create the front-top and front-bottom edge encircling loops, and is shown folded over again on the top face of the body to form the loop for the back-top edge encircling loop, according to an embodiment of the invention;

FIG. 4 is a front elevation view of a version of the invention on a box-like body, with two edge-encircling partially-closed loop straps at the front of the body attached to two of four pylons previously extant on the box-like body, and two optional front stabilizing straps, according to an embodiment of the invention;

FIG. 5 is a side elevation view of a version of the invention on a box-like body, with four edge-encircling loops and side face crossing straps as the securing mechanism, according to an embodiment of the invention;

FIG. 6 is a side elevation view of a version of the invention on a box-like body, with four large edge-encircling loops and a pair of small straps as connectors between these large edge-encircling loops as the securing mechanism, according to an embodiment of the invention; and

FIG. 7 is a side elevation of a version of the invention on a box-like body, with four edge-encircling loops, a material sheet as the securing mechanism which is connected to each of the edge-encircling loops, and an optional pull-up strap for the securing mechanism, according to an embodiment of the invention.

### DETAILED DESCRIPTION

The term strap is used for the long, thin material objects used in the construction of the mounting assembly. A strap may be a sufficiently inelastic and possibly adjustable rope, cord, webbing, or equivalent, possibly with adjustable clips on its ends; nothing besides the strength of the strap under tension is used as an important physical property of the strap in the invention. E.g., it is not important that the strap be flat, though this may improve the aerodynamic properties of the assembly.

By box-like body it is meant any box-like body capable of geometrically supporting the mounting assembly. The box-like body may be a trailer, ISO container, light-rail car, or any equivalent. The box-like body is not to be read-in to the mounting assembly as it is not part of that assembly, but merely the portion of the environment on which the mounting assembly finds itself when the assembly is employed.

The term material sheet is used to mean any sheet of material, semi-rigid cardboard-like placard, tarp, banner, wrapping or equivalent which may be affixed against the box-like body by means of the assembly.

The manner of attaching, fastening, or connecting the material sheet to any part of the assembly, or of attaching any component of the harness to any other component of the harness can vary; it may be something as simple as a knot, such as a sheet-bend, or hitching knot; by means as complex as thermal fusion or sewing together of materials that make up the harness or sheet; by other more mechanical fastening techniques, such as employing straps, carabiners, snaps, or clips to connect the loops or partially-closed loops of the harness to a preferably grommeted hole perforating the sheet or harness; or by equivalents of any of these connection means.

Adjustable fasteners and clipping fasteners are readily added to each of the straps described in the claims of the invention. In general, these additions add ease-of management and adjustability (to different sized box-like bodies, for example).

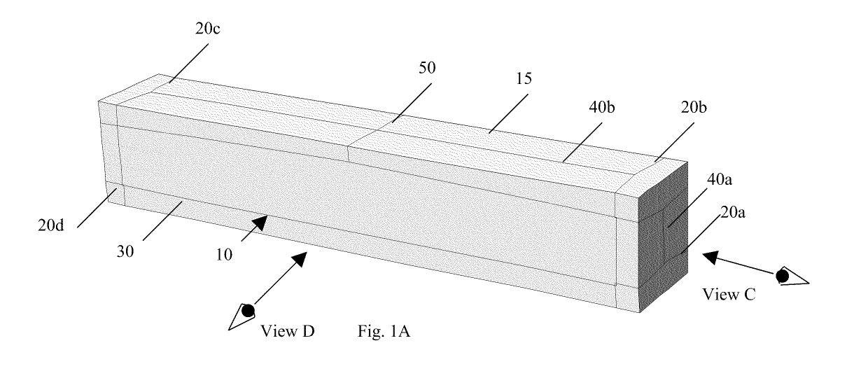

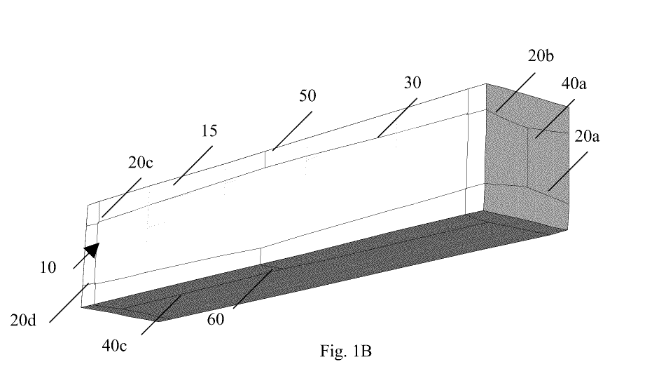

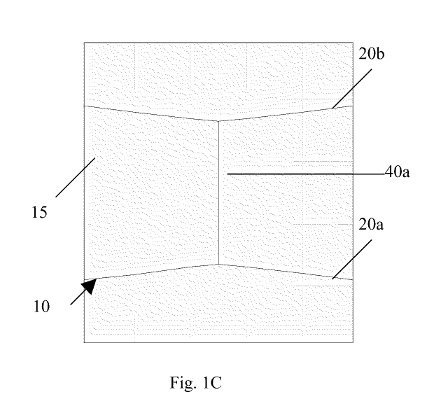

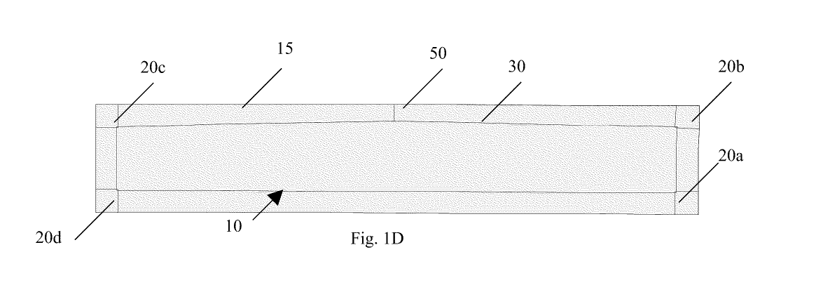

In the particular embodiment of the invention shown in FIG. 1A, the invention includes a mounting assembly 10, wherein the mounting assembly 10 includes: an edge-encircling set of straps, forming at least four geometrically discernible edge loops or geometrically discernible partially-closed edge loops 20a-20d resting around four shorter parallel edges of a box-like body 15: in the particular embodiment shown in FIG. 1A, the four shorter parallel edges depicted are the four horizontal shorter parallel edges, the four vertical shorter parallel edges can just as easily be chosen resulting in a configuration rotated ninety (90) degrees about the longest-running axis of the box-like body 15 from the configuration shown in FIG. 1.

The mounting assembly 10 also includes a securing mechanism 30 configured to secure the edge loops or partially-closed edge loops to their placed position, the securing mechanism 30 including a pair of any one of fasteners, loops, straps, connecting sheets, and sets of straps, each member of the pair resting on one of two opposite length-wise faces of the box-like body 15: in the particular embodiment shown in FIG. 1A, the first opposite length-wise face depicted is the vertical length-wise face, the horizontal opposite length-wise face can just as easily be chosen resulting in a configuration rotated ninety (90) degrees about the longest-running axis of the box-like body 15 from the configuration shown in FIG. 1A, the opposite length-wise faces in either case being connected geometrically by the four shorter parallel edges of the box-like body 15 and the securing mechanism 30 connecting at each of the length-wise faces to the edge loops or partially-closed edge loops 20a-20d so that at each of the length-wise faces the securing mechanism puts the edge loops or partially-closed edge loops 20a-20d under resultant connective tension, whereby the edge loops or partially-closed edge loops 20a-20d resist movement that would cause them to no longer encircle all of the four shorter parallel edges of the box-like body 15.

In the particular embodiment of the invention shown in FIG. 1A, the securing mechanism 30 includes face loop straps 30, the face loop straps 30 forming face loops and resting on the opposite length-wise faces of the box-like body 15.

In the particular embodiment of the invention shown in FIG. 1A, the face loop straps 30 lie on long side faces of the box-like body 15, wherein an area of one of the long side faces is approximately its length (l), a distance, times its height (h), a distance, the face loop straps 30 forming face loops on the long side faces, the face loops forming rectangles having inscribed areas smaller than that of the long side faces, the face loops being approximately a distance p in from the forward and back edges of the side face and approximately a distance q in from the top and bottom edges of each of the long side faces, whereby the face loops each have inscribed areas which are fractions of the area of one of the long side faces and each of the inscribed areas is approximately given by the formula: area=l*h−2*p*h−2*q*l+4*p*q as a distance squared, the face loop straps 30 aiding in substantially preventing the edge-encircling set straps from all moving substantially along a direction of the shorter parallel edges of the box-like body 15.

In the particular embodiment of the invention shown in FIG. 1A, p is about equal to q, and q is about equal to about one foot to about two feet, if the scale of the figure is taken so that the box-like body 15 has dimensions corresponding to a tractor-trailer or an ISO container, whereby a high degree of stability is achieved for the assemblage when placed on tractor-trailers and ISO containers.

In the particular embodiment of the invention shown in FIG. 1A, one or more optional straps 50 lying over a top of the box-like body are attached to each of the face loop straps 30.

In the particular embodiment of the invention shown in FIG. 1A, the edge-encircling set of straps includes four individual loop straps, each as an isolated loop.

In the particular embodiment of the invention shown in FIG. 1A, an optional set of at least four geometrically discernible stabilizing straps 40a-40b running along the front, top, back, and bottom faces of the box-like body 15 are configured, two of which are viewable from this perspective, whereby the stabilizing straps 40a-40b aid in substantially preventing the geometrically discernible loops or partially-closed loops 20a-20d from all moving substantially perpendicular to a direction along any one of the horizontally lying edges.

In the particular embodiment of the invention shown in FIG. 1B, to keep the optional stabilizing strap 40c running along the bottom of the box-like body 15 from getting entangled in any mechanical equipment found on the bottom of the box-like body 15, a strap 60 running from the optional stabilizing strap 40c to a side-face loop strap 30 is shown to be employed to move the bottom stabilizing strap 40c to the side of the bottom face and away from any mechanical devices that may be present on that bottom face. Additional such straps may be employed whenever this avoidance action is further desired.

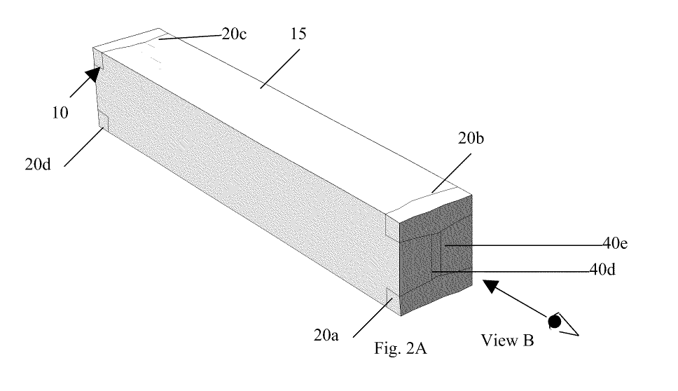

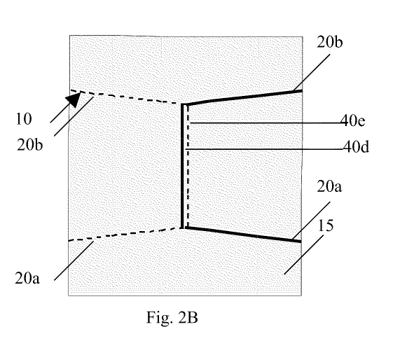

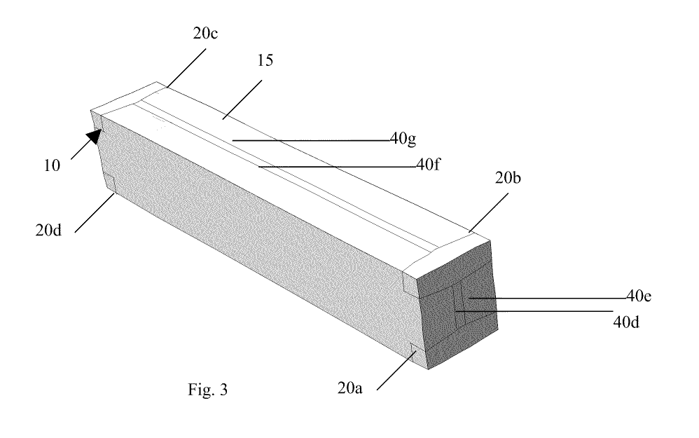

In the particular embodiment of the invention shown in FIG. 2A, the edge-encircling set of straps includes two individual straps and the edge loops or partially-closed edge loops 20a-20d around front and back edges of the box-like body are formed by twisting or fastening to itself each of the two individual loop straps, the places of twisting or fastening 40d-40e lying on a front face and a back face of the box-like body 15. The places of twisting or fastening 40d-40e can just as well lie on two opposite length-wise faces on the box-like body 15, so that one of them would look like the places of twisting or fastening 40f-40g found in FIG. 3.

In the particular embodiment of the invention shown in FIG. 3, the edge-encircling set of straps includes one strap and the edge loops or partially-closed edge loops 20a-20d around front and back edges of the box-like body 15 are formed by twisting or fastening the one loop strap a plurality of times, at three or more places along the strap, the places along the strap of twisting or fastening 40d-40g lying on a front face and a back face of the box-like body 15 and on one length-wise face.

The places along the strap of twisting or fastening lying can just as well lie on two opposite length-wise faces, and on any one of a front face and a back face of the box-like body 15, so that two of the places of twisting of fastening are now on two opposite lengthwise faces, either the horizontal or vertical length-wise faces but otherwise look like the places of twisting or fastening 40f-40g found in FIG. 3 and the remaining place of twisting or fastening is on one of the front or back faces, so that it otherwise looks like the places of twisting or fastening 40d-40e found in FIG. 3.

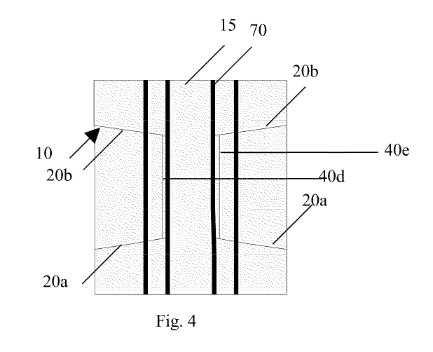

FIG. 4 is a front elevation view of an embodiment of the invention, with two edge-encircling partially-closed loops 20a-20b at the front of the box-like body 15 attached to two of four pylons 70 previously extant on the box-like body 15, and two optional front stabilizing straps 40d-40e; this view may be duplicated for the back of the box-like body 15 if the box-like body 15 provides such attaching means for partially-closed loop straps.

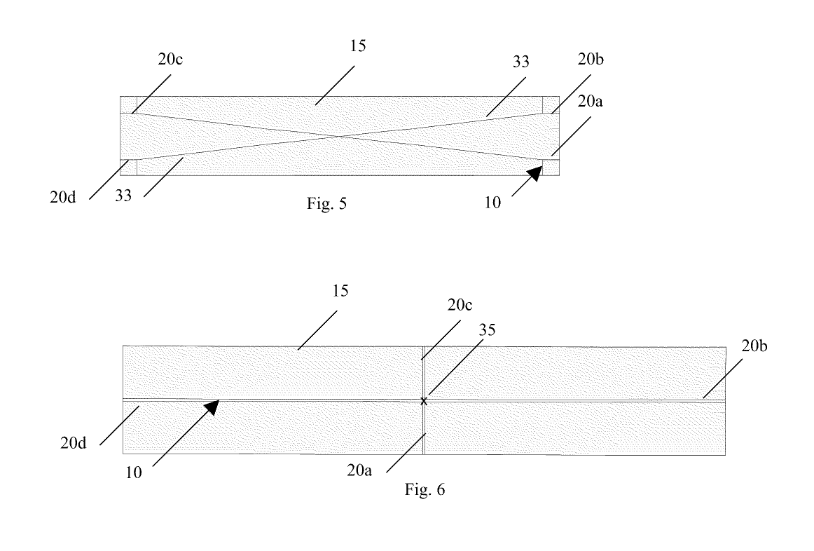

In the particular embodiment of the invention shown in FIG. 5, the securing mechanism includes two pairs of crossed straps, each pair of crossed straps 33 lying across one of the length-wise faces of the box-like body 15 and each crossed strap connecting to a diagonal pair of edge loops or partially-closed edge loops of the edge-encircling set of straps.

In the particular embodiment of the invention shown in FIG. 5, the crossed straps 33 are in their preferred configuration, so are taut when their ends are about one foot to about two feet in from a forward edge and a back edge of each side face and about one foot to about two feet in from a top edge and a bottom edge of each side face, if the scale of the figure is taken so that the box-like body 15 has dimensions corresponding to a tractor-trailer or an ISO container, whereby a high degree of stability is achieved for the assemblage when placed on tractor-trailers and ISO containers.

In the particular embodiment of the invention shown in FIG. 6, there are four large edge-encircling loops and a pair of small straps 35 acting as connectors between these large edge-encircling loops and as the securing mechanism.

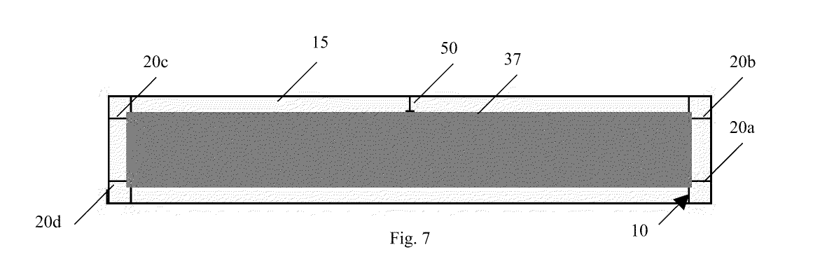

In the particular embodiment of the invention shown in FIG. 7, the securing mechanism includes two material sheets 37 (although only one is shown in this view), each material sheet lying across one of the opposite length-wise faces of the box-like body and each material sheet connecting to the edge-encircling set of straps at corners of the material sheet.

In the particular embodiment of the invention shown in FIG. 7, the two material sheets 37 lie on long side faces of the box-like body 15, wherein an area of one of the long side faces is approximately its length (l), a distance, times its height (h), a distance, the material sheets 37 forming rectangles having areas smaller than that of the long side faces, the material sheets being approximately a distance p in from the forward and back edges of the side face and approximately a distance q in from the top and bottom edges of each of the long side faces, whereby the material sheets 37 each have areas which are fractions of the area of one of the long side faces and each of the areas of the material sheets 37 is approximately given by the formula: area=l*h−2*p*h−2*q*l+4*p*q as a distance squared, the material sheets 37 aiding in substantially preventing the edge loop straps from all moving substantially along a direction of the shorter parallel edges of the box-like body 15.

In the particular embodiment of the invention shown in FIG. 7, p is about equal to q, and q is about equal to about one foot to about two feet, if the scale of the figure is taken so that the box-like body 15 has dimensions corresponding to a tractor-trailer or an ISO container, whereby a high degree of stability is achieved for the assemblage when placed on tractor-trailers and ISO containers.

In the particular embodiment of the invention shown in FIG. 7, an optional strap 50, which could equally well be just an extension of the material sheet 37, thrown over the top of the box-like body 15, is shown; on the obverse side it is attached to a top of the other of the material sheets 37.

Referring to FIGS. 1-7, a plurality of securing points are found on the mounting assembly 10, the securing points may be used to secure one or more material sheets to the box-like body 15 by attaching the material sheets to the securing points. In the preferred employment, the plurality of securing points include the points of connection between the edge-encircling set of straps and the securing mechanism

In the particular embodiment of the invention shown in FIG. 7 the attached material sheet is indistinguishable from the material sheet acting as the securing mechanism 37. In other embodiments the attached material sheet would look similar to this one, also obscuring the other forms of the securing mechanism. Moreover, if the material sheet were made to drape over the box-like body (as would be the case, for example, if the material sheet were are tarp-like covering device), it would lie much as the material sheet extensions do, in place of the strap 50 shown in FIG. 7.

Referring to FIGS. 1-7, a mounting assembly 10 may be formed around a box-like body 15 for mounting large material sheets to the box-like body 15 by, for example, placing an upper-lying part of an edge-encircling set of straps around a front-top edge and a back-top edge of the box-like body 15 to form at least two geometrically discernible edge loops or geometrically discernible partially-closed edge loops 20b-20c resting around the front-top edge and the back-top edge of the box-like body; connecting along two chosen opposite length-wise faces of the box-like body a securing mechanism 30-37 configured to secure the edge loops or partially-closed edge loops to the two edge loops or partially-closed edge loops 20b-20c resting around the front-top edge and the back-top edge of the box-like body; placing a lower-lying part of the edge-encircling set of straps adjacent to a front-bottom edge and a back-bottom edge of the box-like body to form at least two geometrically discernible edge loops or geometrically discernible partially-closed edge loops 20a, 20d resting at the front-bottom edge and the back-bottom edge; and connecting the securing mechanism to the two edge loops or partially-closed edge loops 20a, 20d resting at the front-bottom and back-bottom edges of the box-like body 15; whereby the edge-encircling set of straps form at least four edge loops or partially-closed edge loops 20a-20d in a fixed, snug position around the front-top, front-bottom, back-top and back-bottom edges of the box-like body 15.

For a particular configuration, further adjusting of the securing mechanism 30-37 and the edge-encircling set of straps may prove necessary, which might involve: moving the securing mechanism 30-37 into a substantially fixed, taut state resting against the two length-wise sides of the box-like body 15; and (re-)positioning the edge-encircling set of straps so that they form the edge loops or partially-closed edge loops 20a-20d in a substantially fixed, snug position around the front-top, front-bottom, back-top and back-bottom edges of the box-like body 15; whereby the securing mechanism 30-37 puts the at least four edge loops or partially-closed edge loops 20a-20d under resultant connective tension, whereby the at least four edge loops or partially-closed edge loops 20a-20d resist movement that would cause them to no longer encircle the front-top edge, the front-bottom edge, the back-top edge, and the back-bottom edge of the box-like body 15.

Additional, optional actions may also be taken, these may include, for example, any one of attaching stabilizing straps 40a-40c to the edge-encircling set of straps and identifying geometrical connector segments of the edge-encircling set of straps so that at least four geometrically identifiable stabilizing straps 40a-40c connect between the at least four edge loops or partially-closed edge loops 20a-20d; and positioning the geometrically identifiable stabilizing straps 40a-40c along a front face, a top face, a back face, and a bottom face of the box-like body 15, whereby the stabilizing straps 40a-40c aid in substantially preventing the at least four edge loops or partially-closed edge loops 20a-20d from all moving substantially perpendicular to a direction along any one of the front-top edge, the back-top edge, the front-bottom edge, and the back-bottom edge of the box-like body 15.

If fewer than four individual straps are to be used in the forming of the edge-encircling set of straps, additional actions may be taken, these further including twisting or fastening to itself each of two individual loop straps of the edge-encircling set of straps to form the at least four edge loops or partially-closed edge loops 20a-20d; or twisting or fastening one loop strap a plurality of times, at three or more places along the strap, to form the at least four edge loops or partially-closed edge loops 20a-20d.

Alternately, the assembly 10 may be formed around a box-like body 15 for mounting large material sheets to the box-like body 15 by placing a an edge-encircling set of straps over a first front-side edge, a first back-side edge, a second front-side edge, and a second back-side edge of the box-like body to form at least four geometrically discernible edge loops or geometrically discernible partially-closed edge loops 20a-20d resting around the first front-side edge, the first back-side edge, the second front-side edge, and the second back-side edge of the box-like body; and connecting a securing mechanism 30-37 to the edge loops or partially-closed edge loops 20a-20d along a top face and a bottom face of the box-like body, the securing mechanism 30-37 including any one of fasteners, loops, straps, connecting sheets, and sets of straps; whereby the edge-encircling set of straps are formed into at least four edge loops or partially-closed edge loops 20a-20d in a substantially fixed, snug position.

For a particular configuration, further adjusting of the securing mechanism 30-37 and the edge-encircling set of straps may prove necessary, which might involve: moving the securing mechanism 30-37 into a substantially fixed, taut state resting against at least two length-wise sides of the box-like body 15; and (re-)positioning the edge-encircling set of straps so that they form the at least four edge loops or partially-closed edge loops 20a-20d in a substantially fixed, snug position around the first front-side edge, the first back-side edge, the second front-side edge, and the second back-side edge of the box-like body 15; whereby the securing mechanism 30-37 puts the at least four edge loops or partially-closed edge loops 20a-20d under resultant connective tension, whereby the at least four edge loops or partially-closed edge loops 20a-20d resist movement that would cause them to no longer encircle the first front-side edge, the first back-side edge, the second front-side edge, and the second back-side edge of the box-like body.

Additional, optional actions may also be taken, these including any one of attaching stabilizing straps 40a-40c to the edge-encircling set of straps and identifying geometrical connector segments of the edge-encircling set of straps so that at least four geometrically identifiable stabilizing straps 40a-40c connect between the at least four edge loops or partially-closed edge loops 20a-20d; and positioning the geometrically identifiable stabilizing straps 40a-40c along a front face, a first side face, a back face, and a second side face of the box-like body 15, whereby the stabilizing straps 40a-40c aid in substantially preventing the edge loops or partially-closed edge loops 20a-20d from all moving substantially perpendicular to a direction along any one of the first front-side edge, the first back-side edge, the second front-side edge, and the second back-side edge of the box-like body 15.

If fewer than four individual straps are to be used in the forming of the edge-encircling set of straps, additional actions may be taken, these further including twisting or fastening to itself each of two individual loop straps of the edge-encircling set of straps to form the at least four edge loops or partially-closed edge loops 20a-20d or twisting or fastening one loop strap multiple times, at three or more places along the strap, to form the at least four edge loops or partially-closed edge loops 20a-20d.

I claim:

1. An apparatus comprising a mounting assembly, wherein the mounting assembly comprises:
an edge-encircling set of straps, forming at least four geometrically discernible edge loops or geometrically discernible partially-closed edge loops configured to rest around four shorter parallel edges of a box-like body;
a securing mechanism configured to secure the edge loops or partially-closed edge loops to their placed position, the securing mechanism comprising a pair of any one of fasteners, loops, straps, connecting sheets, and sets of straps, each member of the pair configured to rest on one of two opposite length-wise faces of the box-like body, the opposite length-wise faces being connected geometrically by the four shorter parallel edges of a box-like body and the securing mechanism connecting at each of the length-wise faces to the edge loops or partially-closed edge loops so that at each of the length-wise faces the securing mechanism puts the edge loops or partially-closed edge loops under resultant connective tension, whereby the edge loops or partially-closed edge loops resist movement that would cause them to no longer encircle all of the four shorter parallel edges of the box-like body.

2. The apparatus according to claim 1 wherein the securing mechanism comprises face loop straps, the face loop straps forming face loops and configured to rest on the opposite length-wise faces of the box-like body.

3. The apparatus according to claim 2 wherein the face loop straps lie on long side faces of the box-like body, wherein an area of one of the long side faces is approximately its length, l a distance, times its height, h a distance, the face loop straps forming face loops on the long side faces, the face loops forming rectangles having inscribed areas smaller than that of the long side faces, the face loops being approximately a distance p in from the forward and back edges of the side face and approximately a distance q in from the top and bottom edges of each of the long side faces, whereby the face loops each have inscribed areas which are fractions of the area of one of the long side faces and each of the inscribed areas is approximately given by the formula: area=l*h−2*p*h−2*q*l+4*p*q as a distance squared, the face loop straps aiding in substantially preventing the edge-encircling set of straps from all moving substantially along a direction of the shorter parallel edges of the box-like body.

4. The apparatus of claim 3 wherein p is about equal to q, and q is about equal to about one foot to about two feet.

5. The apparatus as in claim 2, further comprising one or more straps lying over a top of the box-like body and attached to each of the face loop straps.

6. The apparatus according to claim 1 wherein the edge-encircling set of straps comprises four individual loop straps, each as an isolated loop.

7. The apparatus according to claim 1 wherein the edge-encircling set of straps comprises two individual straps and the edge loops or partially-closed edge loops around front and back edges of the box-like body are formed by twisting or fastening to itself each of the two individual loop straps, places of twisting or fastening lying on a front face and a back face of the box-like.

8. The apparatus according to claim 1 wherein the edge-encircling set of straps comprises two individual straps and the edge loops or partially-closed edge loops around two of the four shorter parallel edges of the box-like body are formed by twisting or fastening to itself each of the two individual loop straps, places of twisting or fastening lying on two opposite length-wise faces on the box-like body.

9. The apparatus according to claim 1 wherein the edge-encircling set of straps comprises one strap and the edge loops or partially-closed edge loops around front and back edges of the box-like body are formed by twisting or fastening the one loop strap a plurality of times, at three or more places along the strap, places along the strap of twisting or fastening lying on a front face and a back face of the box-like body and on one length-wise face.

10. The apparatus according to claim 1 wherein the edge-encircling set of straps comprises one strap and the edge loops or partially-closed edge loops around the front and back edges of the box-like body are formed by twisting or fastening the one loop strap a plurality of times, at three or more places along the strap, places along the strap of twisting or fastening lying on two opposite length-wise faces, and on any one of a front face and a back face of the box-like body.

11. The apparatus as in claim 1 further comprising at least four geometrically discernible stabilizing straps running along the front, top, back, and bottom faces of the box-like body, whereby the stabilizing straps aid in substantially preventing the geometrically discernible loops or partially-closed loops from all moving substantially perpendicular to a direction along any one of the horizontally lying edges.

12. The apparatus according to claim 1 wherein the securing mechanism comprises two pairs of crossed straps, each pair of crossed straps lying across one of the length-wise faces of the box-like body and each crossed strap connecting to a diagonal pair of edge loops or partially-closed edge loops of the edge-encircling set of straps.

13. The apparatus according to claims 12 wherein the crossed straps are taut when their ends are about one foot to about two feet in from a forward edge and a back edge of each side face and about one foot to about two feet in from a top edge and a bottom edge of each side face.

14. The apparatus according to claim 1 wherein the securing mechanism comprises two material sheets, each material sheet lying across one of the opposite length-wise faces of the box-like body and each material sheet connecting to the edge-encircling set of straps at corners of the material sheet.

15. The apparatus according to claim 14 wherein the two material sheets lie on long side faces of the box-like body, wherein an area of one of the long side faces is approximately its length (l), a distance, times its height (h), a distance, the material sheets forming rectangles having areas smaller than that of the long side faces, the material sheets being approximately a distance p in from the forward and back edges of the side face and approximately a distance q in from the top and bottom edges of each of the long side faces, whereby the material sheets each have areas which are fractions of the area of one of the long side faces and each of the areas of the material sheets is approximately given by the formula: area=l*h−2*p*h−2*q*l+4*p*q as a distance squared, the material sheets aiding in substantially preventing the edge loop straps from all moving substantially along a direction of the shorter parallel edges of the box-like body.

16. The apparatus of claim 15 wherein p is about equal to q, and q is about equal to about one foot to about two feet.

17. The apparatus as in claim 14 further comprising any one of one or more straps and one or more material sheet extensions lying over the top of the box-like body and attached to a top of each of the material sheets.

18. The apparatus of claim 1 wherein a plurality of securing points are found on the mounting assembly, the securing points being used to secure one or more material sheets to the box-like body by attaching the material sheets to the securing points.

19. The apparatus of claim 18 wherein the plurality of securing points are found at points of connection between the edge-encircling set of straps and the securing mechanism.

20. The apparatus of claim 1 further comprising the box-like body.

21. The apparatus of claim 20 wherein the box-like body is any one of a tractor-trailer trailer and an ISO container.

22. A method of forming an assembly around a box-like body for mounting large material sheets to the box-like body comprising:
placing an upper-lying part of an edge-encircling set of straps around a front-top edge and a back-top edge of the box-like body to form at least two first geometrically discernible edge loops or geometrically discernible partially-closed edge loops resting around the front-top edge and the back-top edge of the box-like body;
connecting along two opposite length-wise faces of the box-like body a securing mechanism configured to secure the first edge loops or partially-closed edge loops to the two first edge loops or partially-closed edge loops, the securing mechanism comprising any one of fasteners, loops, straps, connecting sheets, and sets of straps;
placing a lower-lying part of the edge-encircling set of straps adjacent to a front-bottom edge and a back-bottom edge of the box-like body to form at least two second geometrically discernible edge loops or geometrically discernible partially-closed edge loops resting at the front-bottom edge and the back-bottom edge; and
connecting the securing mechanism additionally configured to secure the second edge loops or partially-closed edge loops to the two second edge loops or partially-closed edge loops;
whereby the edge-encircling set of straps form at least four edge loops or partially-closed edge loops in a substantially fixed, snug position around the front-top, front-bottom, back-top and back-bottom edges of the box-like body.

23. The method of claim 22 further comprising adjusting the securing mechanism and the edge-encircling set of straps, wherein the adjusting comprises:
moving the securing mechanism into a substantially fixed, taut state resting against at least two length-wise sides of the box-like body; and
positioning the edge-encircling set of straps so that they form the edge loops or partially-closed edge loops in a substantially fixed, snug position around the front-top, front-bottom, back-top and back-bottom edges of the box-like body;
whereby the securing mechanism puts the at least four edge loops or partially-closed edge loops under resultant connective tension, whereby the at least four edge loops or partially-closed edge loops resist movement that would cause them to no longer encircle the front-top edge, the front-bottom edge, the back-top edge, and the back-bottom edge of the box-like body.

24. The method of claim 22 further comprising:
any one of attaching stabilizing straps to the edge-encircling set of straps and identifying geometrical connector segments of the edge-encircling set of straps so that at least four geometrically identifiable stabilizing straps connect between the at least four edge loops or partially-closed edge loops; and
positioning the geometrically identifiable stabilizing straps along a front face, a top face, a back face, and a bottom face of the box-like body, whereby the stabilizing straps aid in substantially preventing the at least four edge loops or partially-closed edge loops from all moving substantially perpendicular to a direction along any one of the front-top edge, the back-top edge, the front-bottom edge, and the back-bottom edge of the box-like body.

25. The method of claim 22 wherein the moving of the securing mechanism further comprises forming face loops from face loop straps.

26. The method of claim 22 wherein the moving of the securing mechanism further comprises forming two pairs of crossed connectors from two pairs of crossed straps, each of the pairs of crossed connectors resting on opposite length-wise faces of the box-like body, and along each opposite length-wise face, one crossed connector connecting to and running diagonally from a top-front edge loop or partially-closed edge loop to a bottom-back edge loop or partially-closed edge loop and connecting to the bottom-back edge loop or partially-closed edge loop, and another crossed connector connecting to and running diagonally from a top-back edge loop or partially-closed edge loop to a bottom-front edge loop or partially-closed edge loop and connecting to the bottom-back edge loop or partially-closed edge loop, so that the two connectors cross one-another.

27. The method of claim 22 wherein the moving of the securing mechanism further comprises causing two face material sheets to rest tautly on opposite length-wise faces of the box-like body.

28. The method of claim 22 further comprising twisting or fastening to itself each of two individual loop straps of the edge-encircling set of straps to form the at least four edge loops or partially-closed edge loops.

29. The method of claim 22 further comprising twisting or fastening one loop strap a plurality of times, at three or more places along the strap, to form the at least four edge loops or partially-closed edge loops.

30. A method of forming an assembly around a box-like body for mounting large material sheets to the box-like body comprising:
placing an edge-encircling set of straps over a first front-side edge, a first back-side edge, a second front-side edge, and a second back-side edge of the box-like body to form at least four geometrically discernible edge loops or geometrically discernible partially-closed edge loops resting around the first front-side edge, the first back-side edge, the second front-side edge, and the second back-side edge of the box-like body; and
connecting a securing mechanism to the edge loops or partially-closed edge loops along a top face and a bottom face of the box-like body, the securing mechanism comprising any one of fasteners, loops, straps, connecting sheets, and sets of straps;
whereby the edge-encircling set of straps are formed into at least four substantially fixed edge loops or partially-closed edge loops.

31. The method of claim 30 further comprising adjusting the securing mechanism and the edge-encircling set of straps, wherein the adjusting comprises:
moving the securing mechanism into a substantially fixed, taut state resting against at least two length-wise sides of the box-like body; and
positioning the edge-encircling set of straps so that they form the at least four edge loops or partially-closed edge loops in a substantially fixed, snug position around the first front-side edge, the first back-side edge, the second front-side edge, and the second back-side edge of the box-like body;
whereby the securing mechanism puts the at least four substantially fixed edge loops or partially-closed edge loops under resultant connective tension, whereby the at least four substantially fixed edge loops or partially-closed edge loops resist movement that would cause them to no longer encircle the first front-side edge, the first back-side edge, the second front-side edge, and the second back-side edge of the box-like body.

32. The method of claim 30 further comprising:
any one of attaching stabilizing straps to the edge-encircling set of straps and identifying geometrical connector segments of the edge-encircling set of straps so that at least four geometrically identifiable stabilizing straps connect between the at least four edge loops or partially-closed edge loops; and
positioning the geometrically identifiable stabilizing straps along a front face, a first side face, a back face, and a second side face of the box-like body, whereby the stabilizing straps aid in substantially substantially preventing the edge loops or partially-closed edge loops from all moving substantially perpendicular to a direction along any one of the first front-side edge, the first back-side edge, the second front-side edge, and the second back-side edge of the box-like body.

33. The method of claim 30 wherein the moving of the securing mechanism further comprises forming face loops from face loop straps.

34. The method of claim 30 wherein the moving of the securing mechanism further comprises forming two pairs of crossed connectors from two pairs of crossed straps, each of the pairs of crossed connectors being resting on opposite length-wise faces of the box-like body, and along each opposite length-wise face, one crossed connector connecting to and running diagonally from a first front edge loop or partially-closed edge loop to a first back edge loop or partially-closed edge loop and connecting to the first back edge loop or partially-closed edge loop, and another crossed connector connecting to and running diagonally from a second front edge loop or partially-closed edge loop to a second back edge loop or partially-closed edge loop and connecting to the second back edge loop or partially-closed edge loop, so that the two connectors cross one-another.

35. The method of claim 30 wherein the moving of the securing mechanism further comprises causing two face material sheets to rest tautly on opposite length-wise faces of the box-like body.

36. The method of claim 30 further comprising twisting or fastening to itself each of two individual loop straps of the edge-encircling set of straps to form the at least four substantially fixed edge loops or partially-closed edge loops.

37. The method of claim 30 further comprising twisting or fastening one loop strap a plurality of times, at three or more places along the strap, to form the at least four substantially fixed edge loops or partially-closed edge loops.
